(19) United States
(12) Patent Application Publication
(10) Pub. No.: US 2025/0051667 A1
(43) Pub. Date: Feb. 13, 2025

(54) BIOMASS GASIFICATION AND WASTE INCINERATION INTEGRATED FURNACE

(71) Applicant: HUADIAN ELECTRIC POWER RESEARCH INSTITUTE CO., LTD., Hangzhou, Zhejiang (CN)

(72) Inventor: Zhipeng XUE, Hangzhou, Zhejiang (CN)

(73) Assignee: HUADIAN ELECTRIC POWER RESEARCH INSTITUTE CO., LTD., Hangzhou, Zhejiang (CN)

(21) Appl. No.: 18/699,322

(22) PCT Filed: Sep. 21, 2023
(86) PCT No.: PCT/CN2023/120264

§ 371 Date: Apr. 8, 2024

(30) Foreign Application Priority Data
Aug. 8, 2023 (CN) 202310992910.1

(51) Int. Cl. C10J 3/56; B01D 53/02; C10J 3/86; F23G 5/027; F23G 5/46

(52) U.S. Cl. CPC C10J 3/56; B01D 53/02; C10J 3/86; F23G 5/0273; F23G 5/46; B01D 2253/102; B01D 2257/60; B01D 2257/93; B01D 2258/0291; C10J 2200/09; C10J 2300/0916; C10J 2300/0976; C10J 2300/1246; C10J 2300/16; C10J 2300/1631; C10J 2300/1687; C10J 2300/1807; C10J 2300/1853; C10J 2300/1861; F23G 2206/20; F23G 2900/50001

(57) ABSTRACT

Disclosed is a biomass gasification and waste incineration integrated furnace, which relates to the technical field of biomass gasification and waste incineration, and includes a waste incineration furnace chamber and a biomass gasification furnace chamber. A mutual contact region exists between the waste incineration furnace chamber and the biomass gasification furnace chamber, and heat transfer can be realized between the waste incineration furnace chamber and the biomass gasification furnace chamber. Heat generated by the waste incineration furnace chamber is used for conduction to the biomass gasification furnace chamber, and excess heat generated by the waste incineration can be supplied to the biomass gasification furnace chamber for reactions therein, thereby reducing the heat additionally used by the biomass gasification furnace chamber and saving energy consumption.

This application claims priority to the Chinese Patent Application No. 202310992910.1, titled “BIOMASS GASIFICATION AND WASTE INCINERATION INTEGRATED FURNACE”, filed on Aug. 8, 2023 with the China National Intellectual Property Administration, which is incorporated herein by reference in its entirety.

### FIELD

The present application relates to the technical field of biomass gasification and waste incineration, and in particular to a biomass gasification and waste incineration integrated furnace.

### BACKGROUND

Biomass gasification technology is an environmentally friendly, energy-saving and renewable technology, which transforms biomass materials such as wood, straw and grass into combustible gas and solid by-products (biomass carbon and the like) under a condition of high temperature, high pressure, no oxygen or low oxygen. As an endothermic reaction, a biomass gasification process can be divided into two following process routes according to different heating modes.
1. Indirect heating. In this process route, heat demand for the gasification reaction is fulfilled by providing high-temperature medium from outside, and commonly used external heating media include gas, steam and hot water. In this process, biomass and gasifying agent are heated in a reactor to realize the gasification reaction. This method has higher thermal efficiency, can better control temperature, and is thus favorable for control and optimization of the reaction. Equipment loss that may be caused by combustion of fuel itself can be avoided by this method. However, this process requires additional energy input, which results in increased energy consumption and relative cost.
2. Self-heating gasification. This process route is to provide the heat required for the gasification reaction by partially burning volatile components contained in the biomass itself. In the self-heating gasification, the biomass is heated to a high temperature and part of the volatile components undergo a combustion reaction, generating combustion products and releasing heat to supply the heat required for the gasification reaction. Since the required heat is provided by the partial combustion of the fuel itself, there is no need for additional energy input, which saves energy. This method is relatively simple, convenient to operate, and has low requirements for equipment. However, this method may cause waste of heat, since part of the heat may not be fully utilized during the combustion. Moreover, this method has high quality requirements for fuel, and needs the fuel to generate enough heat to support the reaction.

Waste incineration is a method to dispose municipal solid waste. By burning the solid waste at high temperature, the waste is converted into heat energy, while volume and negative impact of the waste can be reduced. However, the flue gas produced in the process of the waste incineration contains many harmful substances, including dioxins, heavy metals and other pollutants. Dioxin is highly oncogenic, which can do serious harm to human body and environment. Heavy metals such as mercury and plumbum are also toxic substances, which pose potential risks to the ecosystem and human health. In order to reduce the impact of these harmful substances on the environment and human health, appropriate measures must be taken to deal with them.

Activated carbon absorption technology is a commonly used treatment method. By injecting the activated carbon into the flue gas, emission of the pollutants can be reduced by utilizing the adsorption capacity of the activated carbon to the pollutants. The activated carbon has a structure of large pores and a high specific surface area, which can adsorb harmful substances such as organic substances, gaseous pollutants and heavy metals in the flue gas, thus reducing the release of the harmful substances into atmosphere. However, this technology also brings some problems. First of all, the activated carbon itself is an adsorbent which is continuously consumed based on the amount of the flue gas, thus increasing the operating cost. Secondly, problems such as saturation and condensation of the adsorbent may occur in the process of the activated carbon absorption, which may affect the stability and operation effect of the process.

In summary, the activated carbon absorption technology being used in the waste incineration process aims to reduce the emission of dioxins, heavy metals and other pollutants and protect the environment and human health. However, the use of this technology also faces some challenges, and it is necessary to comprehensively consider the operating cost, process stability and treatment effect in order to achieve environmentally friendly waste incineration.

For those skilled in the art, how to solve the heat supply of the biomass gasification process and save energy consumption is a technical problem that needs to be solved at present.

### SUMMARY

A biomass gasification and waste incineration integrated furnace is provided according to the present application, where heat generated by the waste incineration is supplied to the biomass gasification process to save energy consumption, and activated carbon generated by the biomass gasification process is utilized to adsorb exhaust gas of the waste incineration. The specific solutions are as follows.

A biomass gasification and waste incineration integrated furnace includes a waste incineration furnace chamber and a biomass gasification furnace chamber, where a mutual contact region exists between the waste incineration furnace chamber and the biomass gasification furnace chamber, and heat generated in the waste incineration furnace chamber is transferred to the biomass gasification furnace chamber for enabling reaction inside the biomass gasification furnace chamber.

In an embodiment, the biomass gasification and waste incineration integrated furnace further includes a waste heat boiler superheater, a biomass carbon reaction tower and a flue gas dust remover. The waste incineration furnace chamber is provided with a waste feeding port for supplying waste materials. The biomass gasification furnace chamber is provided with a biomass feeding port for supplying biomass materials, a biomass gas outlet for discharging generated gas, a biomass carbon outlet for discharging generated activated carbon, and a steam inlet for inputting steam. The waste heat boiler superheater is provided with a steam outlet for discharging the steam, the biomass carbon reaction tower is provided with a biomass carbon inlet for inputting the activated carbon, and the flue gas dust remover is provided with a flue gas outlet for discharging the flue gas and an ash discharging port for discharging ash. The biomass carbon outlet is connected with the biomass carbon inlet for supplying the activated carbon to the biomass carbon inlet through the biomass carbon outlet, and the steam outlet is connected with the steam inlet for supplying the steam to the steam inlet through the steam outlet.

In an embodiment, the flue gas dust remover is provided with a circulating ash outlet which is connected with the waste feeding port and configured for supplying the ash to the waste feeding port for burnout treatment.

In an embodiment, a ratio of an amount of circulating ash of the circulating ash outlet to an amount of discharged ash of the ash discharging port is proportional to a burnout rate of ash; the ratio of the amount of circulating ash of the circulating ash outlet to the amount of discharged ash of the ash discharging port is proportional to an injection amount of the biomass carbon; and the ratio of the amount of circulating ash to the amount of discharged ash of the ash discharging port is controlled to be between 0.5 and 1.5 during operation.

In an embodiment, the waste incineration furnace chamber includes a waste combustion chamber and a flue gas conveying chamber which are communicated with each other, where the waste combustion chamber is configured for burning the waste, and the flue gas conveying chamber is configured for guiding generated flue gas; and the flue gas conveying chamber is in contact with the biomass gasification furnace chamber and configured for conducting heat.

In an embodiment, the flue gas conveying chamber includes at least two parallel passages arranged in parallel, and the parallel passages extend through the biomass gasification furnace chamber.

In an embodiment, the flue gas conveying chamber includes at least one temperature control passage, and the temperature control passage does not conduct heat to the biomass gasification furnace chamber; a flow temperature control baffle is arranged in the parallel passages and/or the temperature control passage, and the flow temperature control baffle is configured for regulating a flue gas flow ratio between the parallel passages and the temperature control passage.

In an embodiment, a height of the waste incineration furnace chamber is less than that of the biomass gasification furnace chamber, and the parallel passages pass through the biomass gasification furnace chamber.

In an embodiment, the flue gas conveying chamber conveys the flue gas horizontally, and the biomass gasification furnace chamber conveys the biomass materials vertically. The biomass feeding port is arranged at a top portion of the biomass gasification furnace chamber, and the biomass gas outlet is arranged at a side of the top portion. The biomass carbon outlet is arranged at a bottom portion of the biomass gasification furnace chamber, and the steam inlet is arranged at a side of the bottom portion.

In an embodiment, the biomass gasification furnace chamber is a bubbling fluidized bed gasification furnace chamber, which is configured to enable single-time reaction of the biomass materials.

A biomass gasification and waste incineration integrated furnace provided according to the present application includes a waste incineration furnace chamber and a biomass gasification furnace chamber, where a mutual contact region exists between the waste incineration furnace chamber and the biomass gasification furnace chamber, and heat transfer can be realized between the waste incineration furnace chamber and the biomass gasification furnace chamber. Heat generated by the waste incineration furnace chamber is used for conduction to the biomass gasification furnace chamber, and excess heat generated by the waste incineration can be supplied to the biomass gasification furnace chamber for reactions therein, thereby reducing the heat additionally used by the biomass gasification furnace chamber and saving energy consumption.

### BRIEF DESCRIPTION OF THE DRAWINGS

For more clearly illustrating the technical solutions in the embodiments of the present application or in the conventional technology, drawings referred to for describing the embodiments or the conventional technology will be briefly described hereinafter. Apparently, the drawings in the following description are only several examples of the present application, and for those skilled in the art, other drawings may be obtained based on these drawings without any creative efforts.

FIG. 1 is a schematic front view showing a structure of a biomass gasification and waste incineration integrated furnace provided according to the present application;

FIG. 2 is a schematic side view showing a cooperation of a flue gas conveying chamber, a flow temperature control baffle and a biomass gasification furnace chamber; and

FIG. 3 is a schematic top view showing a cooperation of a flue gas conveying chamber, a flow temperature control baffle and a biomass gasification furnace chamber.

Reference numerals in the drawings are listed as follows:
1 waste incineration furnace chamber, 11 waste feeding port, 1.1 waste combustion chamber, 1.2 flue gas conveying chamber, 1.21 parallel passage, 1.22 temperature control passage, 2 flow temperature control baffle, 3 biomass gasification furnace chamber, 31 biomass feeding port, 32 biomass gas outlet, 33 biomass carbon outlet, 34 steam inlet, 4 waste heat boiler superheater, 41 steam outlet, 5 biomass carbon reaction tower, 51 biomass carbon inlet, 6 flue gas dust remover, 61 flue gas outlet, 62 circulating ash outlet, 63 ash discharging port.

### DETAILED DESCRIPTION OF THE EMBODIMENTS

A core of the present application is to provide a biomass gasification and waste incineration integrated furnace. Heat generated by the waste incineration is supplied to the biomass gasification process to save energy consumption, and activated carbon generated by the biomass gasification process is utilized to adsorb exhaust gas of the waste incineration.

In order to enable those skilled in the art to better understand technical solutions of the present application, the biomass gasification and waste incineration integrated furnace according to the present application is further described in detail in conjunction with drawings and specific embodiments.

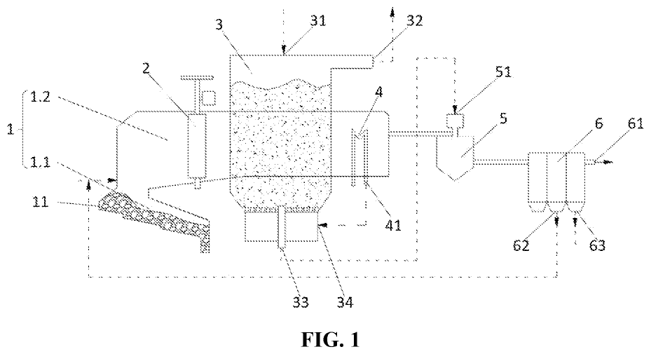

With reference to FIG. 1, a biomass gasification and waste incineration integrated furnace is provided according to the present application, which includes a waste incineration furnace chamber 1 and a biomass gasification furnace chamber 3. The waste incineration furnace chamber 1 and the biomass gasification furnace chamber 3 are provided with inner chambers respectively. The inside of the waste incineration furnace chamber 1 is configured for waste incineration, and the inside of the biomass gasification furnace chamber 3 is configured for biomass gasification.

A mutual contact region exists between the waste incineration furnace chamber 1 and the biomass gasification furnace chamber 3. A mutual contact part of the waste incineration furnace chamber 1 and the biomass gasification furnace chamber 3 is not provided with a heat insulation layer and may be made of heat conducting materials. The heat generated by the waste incineration furnace chamber 1 is used for being conducted to the biomass gasification furnace chamber 3 for reactions therein.

The waste incineration reaction occurs inside the waste incineration furnace chamber 1, and the heat generated by the waste incineration is directly transferred to the biomass gasification furnace chamber 3 through heat conduction. The gasification reaction of biomass materials occurs in the biomass gasification furnace chamber 3, and gas (such as biomass gas, including but not limited to hydrogen gas and carbon monoxide) and biomass carbon (such as activated carbon) are formed after the gasification reaction. The gasification reaction needs the heat supplied from outside. The heat generated by the waste incineration furnace chamber 1 is directly transferred to the biomass gasification furnace chamber 3, which can be used for the gasification reaction inside the biomass gasification furnace chamber 3.

According to the present application, the heat is supplied to the biomass gasification furnace chamber 3 through the heat conduction between the waste incineration furnace chamber 1 and the biomass gasification furnace chamber 3, so that the additional heat used by the biomass gasification furnace chamber 3 can be reduced, or the biomass gasification furnace chamber 3 does not need additional heat from the outside at all. Therefore, the heat generated by the waste incineration furnace chamber 1 can be effectively utilized, and energy consumption can be saved.

On the basis of the above solution, the biomass gasification and waste incineration integrated furnace according to the present application further includes a waste heat boiler superheater 4, a biomass carbon reaction tower 5 and a flue gas dust remover 6. The waste heat boiler superheater 4, the biomass carbon reaction tower 5 and the flue gas dust remover 6 are sequentially arranged in a flow direction of the flue gas. The waste heat boiler superheater 4 is arranged inside the waste incineration furnace chamber 1. The waste incineration furnace chamber 1, the biomass carbon reaction tower 5, and the flue gas dust remover 6 are sequentially communicated for the flue gas to pass through.

The waste heat boiler superheater 4 is configured to generate steam. The activated carbon is filled in the biomass carbon reaction tower 5, so as to capture harmful substances such as heavy metals and dioxins in the flue gas when the flue gas flows through the biomass carbon reaction tower 5. The flue gas in which the harmful substances such as heavy metals and dioxins have been captured is collected by the flue gas dust remover 6.

The waste incineration furnace chamber 1 is provided with a waste feeding port 11 for supplying waste materials, and the waste materials are inputted into the waste incineration furnace chamber 1 through the waste feeding port 11. The biomass gasification furnace chamber 3 is provided with a biomass feeding port 31 for supplying biomass materials, a biomass gas outlet 32 for discharging generated gas, a biomass carbon outlet 33 for discharging generated activated carbon, and a steam inlet 34 for inputting steam. The biomass materials enter the biomass gasification furnace chamber 3 through the biomass feeding port 31, the gas generated by the gasification reaction is discharged through the biomass gas outlet 32, and the biomass carbon generated by the gasification reaction is discharged through the biomass carbon outlet 33. At the same time, the steam from outside enters the biomass gasification furnace chamber 3 through the steam inlet 34, and the steam serves as gasification medium for the gasification reaction in the biomass gasification furnace chamber 3.

With reference to FIG. 1, the waste heat boiler superheater 4 is provided with a steam outlet 41 for discharging the steam, the biomass carbon reaction tower 5 is provided with a biomass carbon inlet 51 for inputting the activated carbon, and the flue gas dust remover 6 is provided with a flue gas outlet 61 for discharging the flue gas and an ash discharging port 63 for discharging ash. The biomass carbon outlet 33 is connected with the biomass carbon inlet 51, and the activated carbon generated by the gasification reaction in the biomass gasification furnace chamber 3 flows to the biomass carbon inlet 51 via the biomass carbon outlet 33 for supplying the activated carbon to the biomass carbon reaction tower 5. The activated carbon absorbs the flue gas inside the biomass carbon reaction tower 5 to capture harmful substances such as heavy metals and dioxins in the flue gas.

It should be noted that the flue gas discharged from the flue gas outlet 61 may directly flow to the next process or flow into the biomass gasification furnace chamber 3 again, and the heat carried by the flue gas may re-enter the biomass gasification furnace chamber 3, which facilitates the heating treatment of the gasification reaction. These specific implementations should be included in the protection scope of the present application.

The steam outlet 41 of the waste heat boiler superheater 4 is connected with the steam inlet 34, so that the steam generated by the waste heat boiler superheater 4 flows to the steam inlet 34 through the steam outlet 41, and the steam is supplied to the biomass gasification furnace chamber 3 as the gasification medium for the gasification reaction in the biomass gasification furnace chamber 3.

That is to say, the biomass gasification and waste incineration integrated furnace according to the present application not only supplies heat to the biomass gasification reaction through the waste incineration reaction, but also supplies activated carbon to the waste incineration reaction through the biomass gasification reaction and uses activated carbon to adsorb the flue gas, so that the activated carbon additionally supplied from the outside is no more needed, or the amount of the activated carbon additionally supplied from the outside is reduced.

With reference to FIG. 1, the flue gas dust remover 6 according to the present application is provided with a circulating ash outlet 62 which is connected with the waste feeding port 11 and configured for supplying ash to the waste feeding port 11 for burnout treatment. Part of the ash in the flue gas dust remover 6 is discharged from the circulating ash outlet 62, and the part of the ash discharged from the circulating ash outlet 62 returns to the waste feeding port 11 as circulating ash for burning-out, so that the ash may be burned more completely.

A ratio of an amount of circulating ash of the circulating ash outlet 62 to an amount of discharged ash of the ash discharging port 63 is proportional to a burnout rate of ash. The ratio of the amount of circulating ash of the circulating ash outlet 62 to the amount of discharged ash of the ash discharging port 63 is proportional to an injection amount of the biomass carbon. The ratio of the amount of circulating ash to the amount of discharged ash of the ash discharging port 63 is controlled to be between 0.5 and 1.5 during operation.

On the basis of any of the above technical solutions or any combination thereof, with reference to FIG. 1, the waste incineration furnace chamber 1 according to the present application includes a waste combustion chamber 1.1 and a flue gas conveying chamber 1.2 which are communicated with each other. The waste combustion chamber 1.1 is located at a lower position and the flue gas conveying chamber 1.2 is located at a higher position. The waste materials fed from the waste feeding port 11 enter the waste combustion chamber 1.1 for accumulation and combustion, and the generated flue gas enters the flue gas conveying chamber 1.2 and flows along the flue gas conveying chamber 1.2 which is configured for guiding the generated flue gas. Since the flue gas carries heat, the flue gas conveying chamber 1.2 is in contact with the biomass gasification furnace chamber 3 and conducts heat, so that the biomass gasification furnace chamber 3 maintains the gasification reaction temperature.

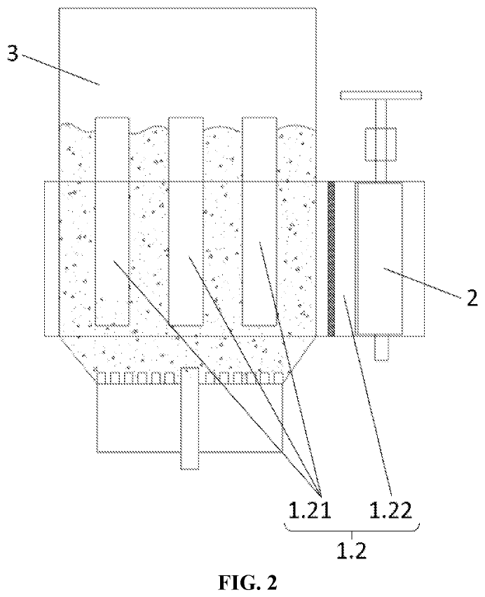

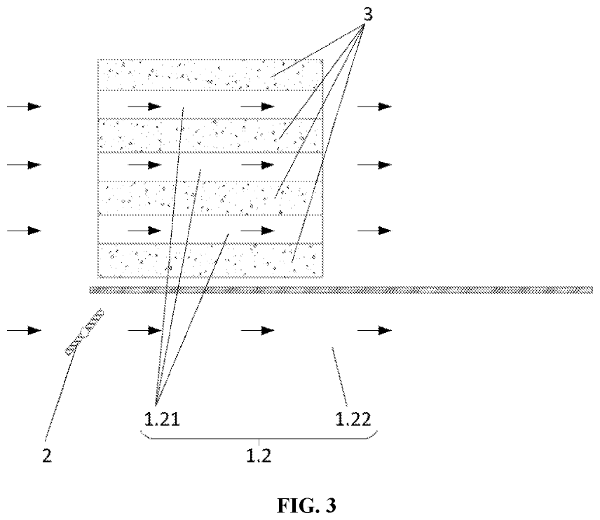

As shown in FIG. 2 and FIG. 3, the flue gas conveying chamber 1.2 includes at least two parallel passages 1.21 arranged in parallel, and each of the parallel passages 1.21 is a relatively separate passage for the flue gas to flow. The flue gas generated by the combustion in the waste combustion chamber 1.1 flows to different parallel passages 1.21, and each of the parallel passages 1.21 separately guides the flue gas to flow. The parallel passages 1.21 are generally distributed in parallel with each other, and the parallel passages 1.21 extend through the biomass gasification furnace chamber 3. Since multiple parallel passages 1.21 are adopted, a side wall of each of the parallel passages 1.21 is in contact with the biomass gasification furnace chamber 3, so that heat conduction area can be increased, and the heat can be conducted to the biomass gasification furnace chamber 3 more evenly.

As shown in FIG. 2 and FIG. 3, the flue gas conveying chamber 1.2 includes at least one temperature control passage 1.22 which is configured for the flue gas to flow. The temperature control passage 1.22 is not in thermal contact with the biomass gasification furnace chamber 3, and the temperature control passage 1.22 does not conduct heat to the biomass gasification furnace chamber 3. The temperature control passage 1.22 and the parallel passages 1.21 are distributed in parallel, and convey the flue gas separately.

A flow temperature control baffle 2 may be arranged in the parallel passages 1.21 and/or the temperature control passage 1.22, that is, the flow temperature control baffle 2 may be arranged in the parallel passages 1.21 or the temperature control passage 1.22 separately, or the flow temperature control baffle 2 may be arranged in both the parallel passages 1.21 and the temperature control passage 1.22. The flow temperature control baffle 2 is configured to regulate a flue gas flow ratio between the parallel passages 1.21 and the temperature control passage 1.22. Opening of the flow temperature control baffle 2 can be regulated, thus changing the flue gas flow of the parallel passages 1.21 or the temperature control passage 1.22. If the temperature of the biomass gasification furnace chamber 3 needs to be raised, the proportion of flue gas in the parallel passages 1.21 is increased, and the proportion of the flue gas in the temperature control passage 1.22 is decreased, so that more flue gas flows through the parallel passages 1.21, allowing more heat being guided to the biomass gasification furnace chamber 3 and the temperature of the biomass gasification furnace chamber 3 being raised. If the temperature of the biomass gasification furnace chamber 3 needs to be lowered, the proportion of flue gas in the parallel passages 1.21 is decreased, and the proportion of the flue gas in the temperature control passage 1.22 is increased, so that less flue gas flows through the parallel passages 1.21, allowing less heat being guided to the biomass gasification furnace chamber 3 and the temperature of the biomass gasification furnace chamber 3 being lowered.

As shown in FIG. 3, arrows indicate the flow direction of the flue gas. In the structure shown in this figure, the flow temperature control baffle 2 is only provided in the temperature control passage 1.22. The temperature of the biomass gasification furnace chamber 3 is controlled by the opening of the flow temperature control baffle 2, and the opening of the flow temperature control baffle 2 (that is, the included angle between the flow temperature control baffle 2 and the horizontal line) ranges from 90 degrees to 180 degrees.

As shown in FIG. 1, a height of the waste incineration furnace chamber 1 is less than that of the biomass gasification furnace chamber 3, and the parallel passages 1.21 pass through the biomass gasification furnace chamber 3. Biomass materials in the biomass gasification furnace chamber 3 are distributed in a space between the parallel passages 1.21, and the heat is conducted to the biomass materials more evenly.

As shown in FIG. 1, the flue gas conveying chamber 1.2 conveys the flue gas horizontally, and the biomass gasification furnace chamber 3 conveys the biomass materials vertically. The biomass feeding port 31 is arranged at a top portion of the biomass gasification furnace chamber 3, and the biomass gas outlet 32 is arranged at a side of the top portion. The biomass carbon outlet 33 is arranged at a bottom portion of the biomass gasification furnace chamber 3, and the steam inlet 34 is arranged at a side of the bottom portion. The biomass materials are supplied to the biomass gasification furnace chamber 3 from the biomass feeding port 31 at the top portion, the gas generated by the gasification reaction flows upward and is discharged from the biomass gas outlet 32, and the activated carbon generated by the gasification reaction is discharged from the biomass carbon outlet 33 at the bottom portion.

The biomass gasification furnace chamber 3 is a bubbling fluidized bed gasification furnace chamber, which is configured to enable single-time reaction of the biomass materials. The biomass materials do not react circularly in the biomass gasification furnace chamber 3, so that more activated carbon can be generated for flue gas adsorption.

Compared with the conventional technology, the present application has the following advantages.
1. Self-provided heat source for the biomass gasification. A conventional technology for the biomass gasification generally needs energy from outside to provide heat source for the gasification process, which increases energy consumption and operating costs. According to the present application, the hot flue gas provided by the waste incineration exchanges heat with the bubbling fluidized bed gasification furnace chamber, so that the self-sufficiency of the heat source required for the biomass gasification is realized, and the problem of dependence on external energy sources in the conventional system is solved.
2. Self-provided flue gas purification system with endogenous activated carbon. In a process of flue gas purification in the waste incineration, a large amount of activated carbon is always needed to capture and adsorb pollutants, which leads to a large demand for the activated carbon, high replacement frequency and increased operating costs. According to the present application, the biomass carbon generated in the process of the biomass gasification is used as activated carbon which is sprayed into the flue gas to capture the pollutants such as heavy metals and dioxins, so that internal supply of the activated carbon required for the flue gas purification in the waste incineration system is realized, and the demand for the activated carbon from outside is reduced.
3. Improved fuel adaptability. The conventional technology has a poor adaptability to the fuel, and can only deal with specific types of biomass, such as wood or straw. The fuel category can be applied in the conventional technology is quite limited, which limits its application scope. The present application integrates two systems of biomass and industrial waste, which is not only suitable for the gasification of natural biomass, but also suitable for the incineration of industrial waste, thus solving the problem of limited fuel category in the conventional technology. Besides, by-products produced by the biomass gasification can be used for power generation or direct combustion, which enhances the fuel adaptability and comprehensive energy utilization efficiency of the system.
4. Flexible control ability. The conventional biomass gasification process requires high precision of temperature control. An over low temperature may result in a slow reaction rate and incomplete product formation; while an over high temperature may result in product quality degradation and equipment damage. According to the present application, the flow rate of the heating medium is accurately controlled through the flow temperature control baffle, so that the gasification reaction temperature is accurately controlled. Besides, the efficiency and stability of the gasification reaction is improved, the corrosion and wear of gasification equipment is reduced, and the product quality and energy utilization efficiency are increased.
5. Increased burn-out rate by circulating ash combustion. In the conventional technology, the activated carbon injected in the waste incineration process directly enters the flue gas dust remover after capturing dioxins and heavy metals, and its own heat value is completely wasted. In the present application, part of the ash in the flue gas dust remover is returned to the waste incineration furnace chamber as circulating ash to achieve a purpose of improving combustion efficiency and reducing the emission of harmful substances.

A specific embodiment is provided according to the present application. Biomass materials in this embodiment involve rice husks, straws and forestry waste, and their industrial analysis and elemental analysis are as follows.

TABLE 1
Industrial analysis and elemental analysis of raw materials

| | | Rice | Forestry | | Industrial |
|---|---|---|---|---|---|
| Item | Unit | husks | waste | Straws | waste |
| Total moisture | % | 10.5 | 22.6 | 16.7 | 49.09 |
| Ash As-received Basis | % | 9.71 | 16.27 | 12.02 | 27.97 |
| Volatile Matter As-received Basis | % | 14.87 | 18.02 | 15.35 | 19.83 |
| Fixed Carbon As-received Basis | % | 58.19 | 46.66 | 51.09 | 3.11 |
| Higher Heat Value As-received Basis | MJ/kg | 37.27 | 31.07 | 34.98 | 39.33 |
| Lower Heat Value As-received Basis | MJ/kg | 4.09 | 3.19 | 3.41 | 4.05 |
| Total Sulfur Content | % | 0.30 | 0.72 | 0.60 | 0.35 |
| Carbon Content As-received Basis | % | 32.94 | 24.36 | 28.90 | 55.62 |
| Hydrogen Content As-received Basis | % | 0.03 | 0.04 | 0.06 | 7.98 |
| Nitrogen Content As-received Basis | % | 14.76 | 11.89 | 13.49 | 1.70 |
| Oxygen Content As-received Basis | % | 13.68 | 10.71 | 12.40 | 34.39 |

Working condition 1: 100% rice husk is burnt in the biomass gasification furnace chamber 3. Under 100% load, consumption of the biomass material is 7.26 t/h, flow rate of the biomass gas generated after gasification is 12,857 m3/h, temperature of the biomass gas is 702.4° C., lower heat value of wet biomass gas is 3.349 MJ/m3, gas production rate is 1.771 m3/kg, and carbon production rate is 0.242 kg/kg. The consumption of waste is 70 t/day, and injection amount of the biomass carbon is about 2.91 kg/h.
Working condition 2: 50% rice husk plus 50% forestry waste is burnt in the biomass gasification furnace chamber 3. Under 100% load, consumption of the biomass material is 8.48 t/h, flow rate of the biomass gas is 17,304 m3/h, temperature of the biomass gas is 698.4° C., lower heat value of wet biomass gas is 3.128 MJ/m3, gas production rate is 1.546 m3/kg, and carbon production rate is 0.271 kg/kg. The consumption of waste is 70 t/day, and injection amount of the biomass carbon is about 2.91 kg/h.
Working condition 3: 100% straw is burnt in the biomass gasification furnace chamber 3. Under 100% load, consumption of the biomass material is 8.54 t/h, flow rate of the biomass gas generated after gasification is 18,267 m3/h, temperature of the biomass gas is 688.4° C., lower heat value of wet biomass gas is 2.926 MJ/m3, gas production rate is 1.685 m3/kg, and carbon production rate is 0.312 kg/kg. The consumption of waste is 70 t/day, and injection amount of the biomass carbon is about 2.91 kg/h.

According to the above description of the disclosed embodiments, those skilled in the art can implement or practice the present application. Many modifications to these embodiments are apparent to those skilled in the art. The general principles defined herein may be applied to other embodiments without departing from the spirit or scope of the present application. Therefore, the present application should not be limited to the embodiments disclosed herein, but should conform to the widest scope in accordance with the principles and the novel features disclosed herein.

1. A biomass gasification and waste incineration integrated furnace, comprising a waste incineration furnace chamber and a biomass gasification furnace chamber; wherein
a mutual contact region exists between the waste incineration furnace chamber and the biomass gasification furnace chamber, and heat generated in the waste incineration furnace chamber is transferred to the biomass gasification furnace chamber for enabling reaction inside the biomass gasification furnace chamber.

2. The biomass gasification and waste incineration integrated furnace according to claim 1, further comprising a waste heat boiler superheater, a biomass carbon reaction tower and a flue gas dust remover; wherein
the waste incineration furnace chamber is provided with a waste feeding port for supplying waste materials;
the biomass gasification furnace chamber is provided with a biomass feeding port for supplying biomass materials, a biomass gas outlet for discharging generated gas, a biomass carbon outlet for discharging generated activated carbon, and a steam inlet for inputting steam;
the waste heat boiler superheater is provided with a steam outlet for discharging the steam;
the biomass carbon reaction tower is provided with a biomass carbon inlet for inputting the activated carbon;
the flue gas dust remover is provided with a flue gas outlet for discharging the flue gas and an ash discharging port for discharging ash; and
the biomass carbon outlet is connected with the biomass carbon inlet for supplying the activated carbon to the biomass carbon inlet through the biomass carbon outlet; and the steam outlet is connected with the steam inlet for supplying the steam to the steam inlet through the steam outlet.

3. The biomass gasification and waste incineration integrated furnace according to claim 2, wherein the flue gas dust remover is provided with a circulating ash outlet which is connected with the waste feeding port and configured for supplying the ash to the waste feeding port for burnout treatment.

4. The biomass gasification and waste incineration integrated furnace according to claim 3, wherein a ratio of an amount of circulating ash of the circulating ash outlet to an amount of discharged ash of the ash discharging port is proportional to a burnout rate of ash;
the ratio of the amount of circulating ash of the circulating ash outlet to the amount of discharged ash of the ash discharging port is proportional to an injection amount of the biomass carbon; and
the ratio of the amount of circulating ash to the amount of discharged ash of the ash discharging port is controlled to be between 0.5 and 1.5 during operation.

5. The biomass gasification and waste incineration integrated furnace according to claim 1, wherein the waste incineration furnace chamber comprises a waste combustion chamber and a flue gas conveying chamber which are communicated with each other, wherein the waste combustion chamber is configured for burning the waste, and the flue gas conveying chamber is configured for guiding generated flue gas; and
the flue gas conveying chamber is in contact with the biomass gasification furnace chamber and configured for conducting heat.

6. The biomass gasification and waste incineration integrated furnace according to claim 5, wherein the flue gas conveying chamber comprises at least two parallel passages arranged in parallel, and the parallel passages extend through the biomass gasification furnace chamber.

7. The biomass gasification and waste incineration integrated furnace according to claim 6, wherein the flue gas conveying chamber comprises at least one temperature control passage, and the at least one temperature control passage does not conduct heat to the biomass gasification furnace chamber; and
a flow temperature control baffle is arranged in the parallel passages and/or the temperature control passage, and the flow temperature control baffle is configured for regulating a flue gas flow ratio between the parallel passages and the temperature control passage.

8. The biomass gasification and waste incineration integrated furnace according to claim 6, wherein a height of the waste incineration furnace chamber is less than that of the biomass gasification furnace chamber, and the parallel passages pass through the biomass gasification furnace chamber.

9. The biomass gasification and waste incineration integrated furnace according to claim 6, wherein the flue gas conveying chamber conveys the flue gas horizontally, and the biomass gasification furnace chamber conveys the biomass materials vertically; and
the biomass feeding port is arranged at a top portion of the biomass gasification furnace chamber, and the biomass gas outlet is arranged at a side of the top portion; the biomass carbon outlet is arranged at a bottom portion of the biomass gasification furnace chamber, and the steam inlet is arranged at a side of the bottom portion.

10. The biomass gasification and waste incineration integrated furnace according to claim 6, wherein the biomass gasification furnace chamber is a bubbling fluidized bed gasification furnace chamber, which is configured to enable single-time reaction of the biomass materials.

11. The biomass gasification and waste incineration integrated furnace according to claim 2, wherein the waste incineration furnace chamber comprises a waste combustion chamber and a flue gas conveying chamber which are communicated with each other, wherein the waste combustion chamber is configured for burning the waste, and the flue gas conveying chamber is configured for guiding generated flue gas; and
the flue gas conveying chamber is in contact with the biomass gasification furnace chamber and configured for conducting heat.

12. The biomass gasification and waste incineration integrated furnace according to claim 3, wherein the waste incineration furnace chamber comprises a waste combustion chamber and a flue gas conveying chamber which are communicated with each other, wherein the waste combustion chamber is configured for burning the waste, and the flue gas conveying chamber is configured for guiding generated flue gas; and
the flue gas conveying chamber is in contact with the biomass gasification furnace chamber and configured for conducting heat.

13. The biomass gasification and waste incineration integrated furnace according to claim 4, wherein the waste incineration furnace chamber comprises a waste combustion chamber and a flue gas conveying chamber which are communicated with each other, wherein the waste combustion chamber is configured for burning the waste, and the flue gas conveying chamber is configured for guiding generated flue gas; and
the flue gas conveying chamber is in contact with the biomass gasification furnace chamber and configured for conducting heat.
